(19) United States
(12) Patent Application Publication
(10) Pub. No.: US 2013/0096999 A1
(43) Pub. Date: Apr. 18, 2013

(54) METHOD AND SYSTEM FOR SELLING A PRODUCT ONLINE

(71) Applicants: Wen-Jung Hsueh, Tainan City (TW); Hsin Lee, Tainan City (TW)

(72) Inventors: Wen-Jung Hsueh, Tainan City (TW); Hsin Lee, Tainan City (TW)

(21) Appl. No.: 13/274,073

(22) Filed: Oct. 14, 2011

(51) Int. Cl. G06Q 30/02

(52) U.S. Cl. 705/14.14

(57) ABSTRACT

A method of selling a product online over the Internet is to be performed by a server device, and includes the steps of: a) configuring the server device to receive customer-identification information from at least one customer who has decided to purchase the product; b) configuring the server device to associate at least one of a plurality of identifiers with the customer-identification information; c) configuring the server device to select at least one of the identifiers according to a predetermined scheme when a predetermined termination condition is satisfied; and d) configuring the server device to conduct, with the at least one customer, transaction for the product. Whether or not a benefit associated with purchase of the product is provided to the at least one customer is based on the selected identifiers.

### BACKGROUND OF THE INVENTION

1. Field of the Invention

The present invention relates to a method and a system for selling a product online, more particularly to a method and a system for selling a product online and for providing a benefit to selected customers.

2. Description of the Related Art

The trend of internet shopping activities has been growing rapidly in many countries. In most online shopping systems, product sellers would generally provide product information in a variety of forms, such as electronic catalogues, and may gain extra exposure by purchasing various advertisement packages offered by various multimedia platforms, such as portal websites and television channels. In addition, some product sellers may deliver advertisements via electronic mail.

However, such methods of exposing product information may be considered invasive and may be regarded as a form of burden especially by those who did not solicit for such information, which may render the advertisements ineffective and may even result in negative impressions of the products.

### SUMMARY OF THE INVENTION

Therefore, an object of the present invention is to provide a method of selling a product that is capable of alleviating the aforesaid drawbacks of the prior art.

According to the present invention, a method of selling a product online over the Internet is to be performed by a server device, and includes the steps of: a) configuring the server device to receive customer-identification information from at least one customer who has decided to purchase the product; b) configuring the server device to associate at least one of a plurality of identifiers with the customer-identification information; c) configuring the server device to select at least one of the identifiers according to a predetermined scheme when a predetermined termination condition is satisfied; and d) configuring the server device to conduct, with said at least one customer, transaction for the product, wherein whether or not a benefit associated with purchase of the product is provided to said at least one customer is based on said at least one of the identifiers selected in step c).

Another object of the present invention is to provide a system for selling a product that is capable of alleviating the aforesaid drawbacks of the prior art.

According to the present invention, a system for selling a product online over the Internet includes a server that is configured: to receive customer-identification information from at least one customer who has decided to purchase the product; to associate at least one of a plurality of identifiers with the customer-identification information; to select at least one of the identifiers according to a predetermined scheme when a predetermined termination condition is satisfied; and to conduct, with the at least one customer, transaction for the product, wherein whether or not a benefit associated with purchase of the product is provided to the at least one customer is based on the at least one of the identifiers selected by the server device.

### BRIEF DESCRIPTION OF THE DRAWINGS

Other features and advantages of the present invention will become apparent in the following detailed description of the preferred embodiment with reference to the accompanying drawings, of which:

FIG. 1 is a block diagram to illustrate the preferred embodiment of a system for selling a product online over the Internet according to the present invention;

FIG. 2 is a flowchart to illustrate steps of the preferred embodiment of a method of selling a product online over the Internet according to the present invention;

FIG. 3 is a portion of a display region on a display unit of a client device presenting description information and identifiers associated with a data entry;

FIG. 4 is one modification of visual presentation of description information and identifiers associated with a data entry; and

FIG. 5 is another modification of visual presentation of description information and identifiers associated with a data entry.

### DETAILED DESCRIPTION OF THE PREFERRED EMBODIMENT

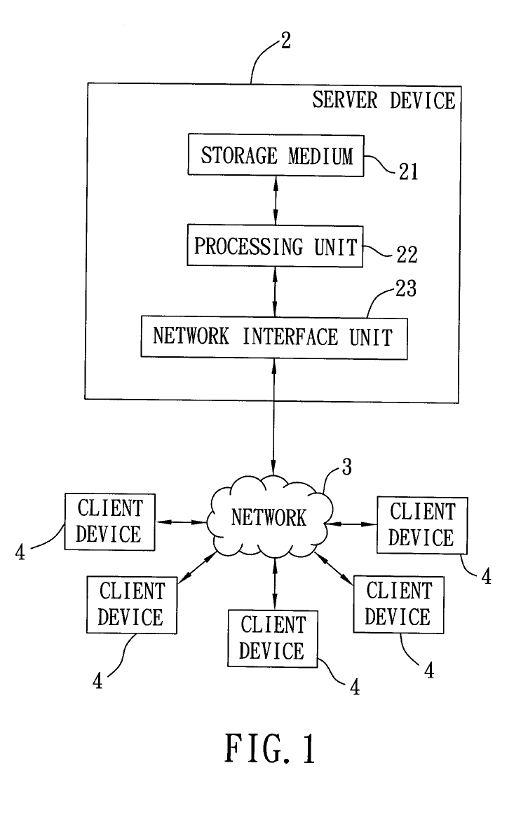

Referring to FIG. 1, the first preferred embodiment of a system for selling a product online over the Internet includes a server device 2 including a storage medium 21, a processing unit 22 that is coupled electrically to the storage medium 21, and a network interface unit 23 that is coupled electrically to the processing unit 22. The processing unit 22 is configured to communicate with a plurality of client devices 4 (e.g., portable computers and mobile phones) through the network interface unit 23 via a network 3 (e.g., the Internet). It is to be noted that the term “product” as used herein can be a manufactured article or a service provided by a service provider.

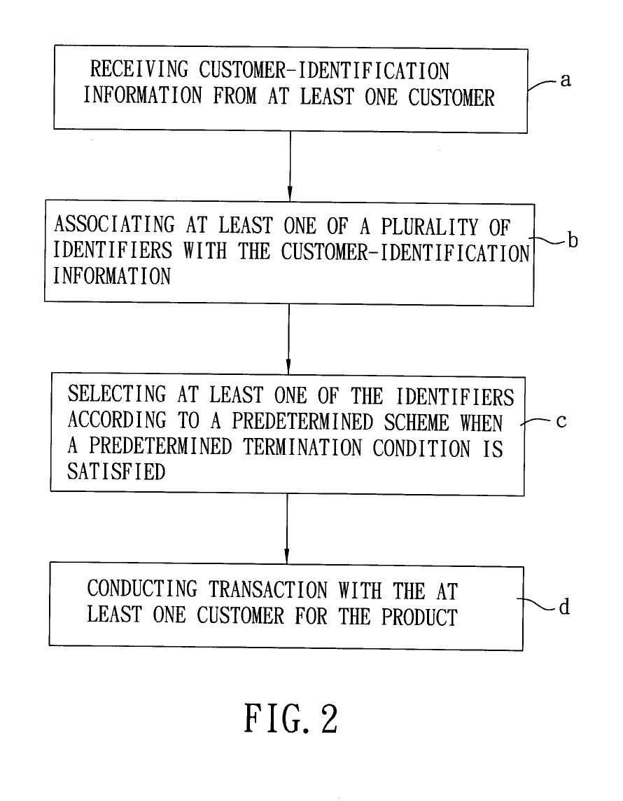

Referring to FIG. 2, the server device 2 is configured to perform steps of the preferred embodiment of a method of selling a product online over the Internet.

In an exemplary scenario, the storage medium 21 has a plurality of data entries stored therein, each of which corresponds to a product to be sold, and is associated with description information (e.g., a product-related image with accompanying descriptive text) and a predetermined set of identifiers.

A customer who has decided to purchase one of the products may operate one of the client devices 4 to request the server device 2 for the description information and the identifiers associated with one of the data entries that corresponds to said one of the products. In response to the user request, the server device 2 is configured to provide the description information and the identifiers associated with said one of the data entries to the customer.

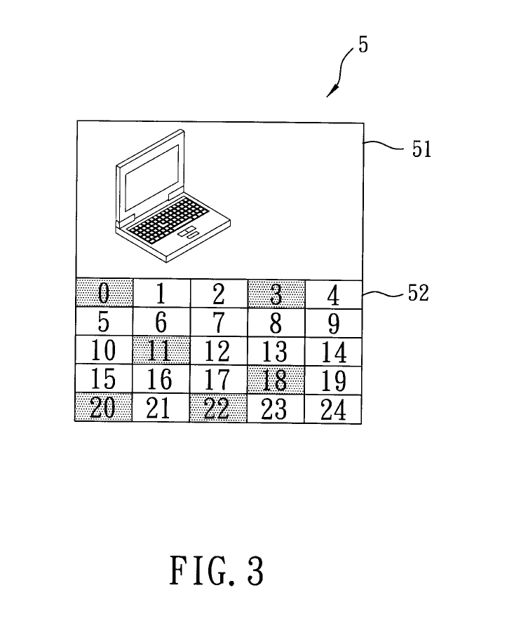

Upon receipt of the description information and the identifiers, said one of the client devices 4, which preferably includes a display unit, is configured to present the description information and the identifiers received thereby on the display unit. FIG. 3 shows a display region 5 on the display unit of said one of the client devices 4 presenting the description information and the identifiers. The display region 5 has a first sub-region 51 corresponding to the description information, and a second sub-region 52 corresponding to the identifiers.

The identifiers may be assigned with one of various numerals. In this embodiment, the identifiers with which said one of the data entries is associated are assigned with numerical values in sequence ranging from 0 to 24 and are visually presented in the second sub-region 52 in an ascending order and in the form of a 5-by-5 matrix. However, it should be noted that the identifiers may be otherwise in other embodiments, and that visual presentation of the description information and the identifiers is not limited to such.

The customer may further operate said one of the client devices 4 to register his/her interest in said one of the products. Specifically, the customer may operate said one of the client devices 4 to provide to the server device 2 identifier-select information that corresponds to said one of the data entries, and customer-identification information that corresponds to the customer.

Upon receipt of the identifier-select information and the customer-identification information, the server device 2 is configured to associate at least one of the identifiers, that are associated with said one of the data entries, with the customer-identification information according to the identifier-select information. In a modification, the server device 2 is configured to receive only the customer-identification information from the customer, and to associate at least a randomly selected one of the identifiers, that are associated with said one of the data entries, with the customer-identification information received thereby.

In this embodiment, areas of the second sub-region corresponding to identifiers that have been registered (i.e., associated with customer-identification information) are visually presented to distinguish from those areas of the second sub-region 52 corresponding to identifiers that have not been registered. In this embodiment, registered ones of the identifiers are presented in a darker color compared to non-registered identifiers. In the exemplary scenario, identifiers that have been registered may not be registered again with different customer-identification information.

Preferably, a look-up table of the identifiers and the customer-identification information associated therewith is stored in the storage medium 21 of the server device 2.

Each of the data entries is further associated with a predetermined termination condition. In this embodiment, the predetermined termination condition of said one of the data entries is satisfied when external numerical information has become available. When the predetermined termination condition of said one of the data entries is satisfied, the server device 2 is configured to select a predetermined number of the identifiers associated with said one of the data entries according to a predetermined scheme with reference to the external numerical information. It is to be noted that the predetermined termination condition may be otherwise in other embodiments. For example, the predetermined termination condition may be satisfied when a predetermined time is reached, and/or when a predetermined number of the identifiers have been associated with customer-identification information.

In this embodiment, the external numerical information is a lottery result. The predetermined scheme includes summing numbers of the lottery result to obtain a sum, performing a square calculation upon the sum thus obtained to obtain an intermediate number, and performing a modulo-25 calculation upon the intermediate number to obtain a result number. After obtaining the result number, the server device 2 is configured to select one of the identifiers having the numerical value that matches the result number thus obtained. In other embodiments, the external numerical information may be selected from such as a sports match result, an election result, and a combination thereof.

Next, the server device 2 is configured to conduct, with the customers, transaction for the product. The customer whose customer-identification information is associated with the selected one of the identifiers (hereinafter referred to as the winning customer) may be provided with a predetermined benefit, which, in this embodiment, is a reduced price for purchase of the product associated with said one of the data entries.

It is worth noting that the predetermined scheme and the predetermined termination condition may be disclosed to potential customers upon request for the description information and the identifiers, thereby eliminating customer concerns of cheating during selection of the identifiers. Moreover, in other embodiments, the winning customer may be provided with other benefits, such as extra reward points and buy-one-get-one-free.

Preferably, customers deciding to purchase a product through the server device 2 have to pay a deposit, which is a fraction of the original product price, or deduct points from their accounts before being able to be associated with the identifiers.

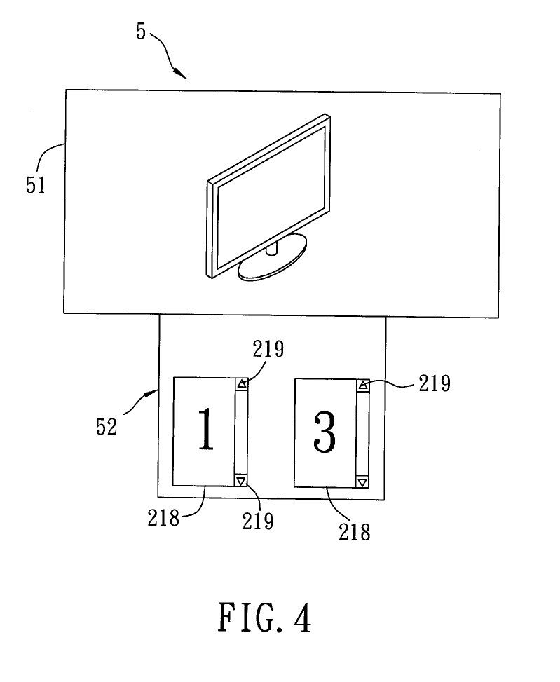

FIG. 4 shows a modified visual presentation of the description information and the identifiers. Instead of presenting the identifiers in the form of a matrix, the second sub-region 52 of the display region 5 has two digit slots 218, each associated with up and down arrow operators 219 for user manipulation to select the numerical digit to be presented in the respective digit slot 218. As mentioned above, registered identifiers are visually presented to distinguish from non-registered identifiers. It is noted that the actual number of the digit slots may vary depending on the number of products available for purchase.

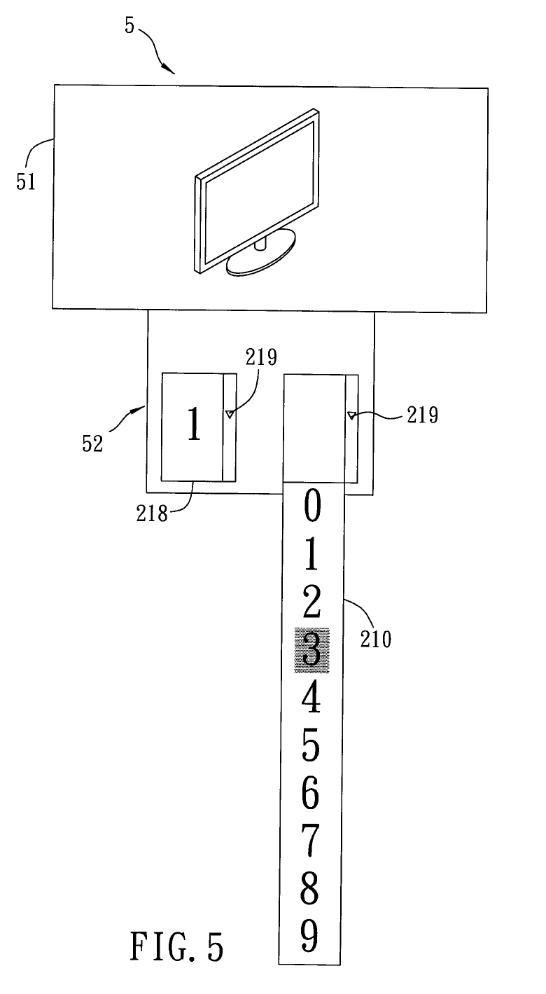

FIG. 5 shows another modified visual presentation of the description information and the identifiers. Unlike the arrangement in FIG. 4, each digit slot 218 is associated with only one arrow operator 219 for user manipulation to present a scroll window 210 from which the user may then select the numerical digit to be presented in the respective digit slot 218.

In summary, the preferred embodiment of a method of selling a product online over the Internet is capable of attracting customers' interests by providing benefits to selected customers through a transparent customer-selection scheme.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A method of selling a product online over the Internet, said method utilizing a server device and comprising the steps of:
configuring the server device to receive customer-identification information from at least one customer who has decided to purchase the product;
configuring the server device to associate at least one of a plurality of identifiers with the customer-identification information;
configuring the server device to select at least one of the identifiers according to a predetermined scheme when a predetermined termination condition is satisfied; and
configuring the server device to conduct, with said at least one customer, transaction for the product, wherein whether or not a benefit associated with purchase of the product is provided to said at least one customer is based on said at least one of the identifiers selected according to the predetermined condition.

2. The method as claimed in claim 1, wherein the server device is configured to select the at least one of the identifiers according to the predetermined scheme with reference to external numerical information.

3. The method as claimed in claim 2, wherein the external numerical information is selected from a lottery result,
a sports match result, an election result, and combinations thereof.

4. The method as claimed in claim 3, wherein the predetermined termination condition is satisfied when the external numerical information has become available.

5. The method as claimed in claim 2, wherein each of the identifiers is associated with a unique numerical value, and the predetermined scheme includes performing mathematical computation processing upon the external numerical information, wherein said at least one of the identifiers is selected according to result of the mathematical computation processing.

6. The method as claimed in claim 1, wherein, the predetermined termination condition is one of: a predetermined time is reached; and a predetermined number of the identifiers have been associated with the customer-identification information.

7. The method as claimed in claim 1, wherein, the predetermined scheme and the predetermined termination condition are known to said at least one customer.

8. The method as claimed in claim 1, wherein the server device is further configured to receive identifier-select information from said at least one customer, and the server device is configured to associate said at least one of the identifiers with the customer-identification information according to the identifier-select information.

9. The method as claimed in claim 1, wherein the server device is configured to associate a randomly selected one of the identifiers with the customer-identification information.

10. The method as claimed in claim 1, wherein the benefit is a reduced price for purchase of the product.

11. The method as claimed in claim 10, wherein the benefit is provided to said at least one customer associated with said at least one of the identifiers selected.

12. The method as claimed in claim 1, wherein configuring the server device to associate at least one of a plurality of identifiers with the customer-identification information includes storing a look-up table of the identifiers and the customer-identification information associated therewith in a storage medium of the server device.

13. A system for selling a product online over the Internet, said system comprising a server device configured to:
receive customer-identification information from at least one customer who has decided to purchase the product;
associate at least one of a plurality of identifiers with the customer-identification information;
select at least one of the identifiers according to a predetermined scheme when a predetermined termination condition is satisfied; and
conduct, with said at least one customer, transaction for the product, wherein whether or not a benefit associated with purchase of the product is provided to said at least one customer is based on said at least one of the identifiers selected by said server device.

14. The system as claimed in claim 13, wherein the server device is configured to select the at least one of the identifiers according to the predetermined scheme with reference to external numerical information.

15. The system as claimed in claim 14, wherein the predetermined termination condition is satisfied when the external numerical information has become available.

16. The system as claimed in claim 14, wherein each of the identifiers is associated with a unique numerical value, and the predetermined scheme includes performing mathematical computation processing upon the external numerical information, wherein said at least one of the identifiers is selected according to result of the mathematical computation processing.

17. The system as claimed in claim 13, wherein the predetermined termination condition is one of: a predetermined time is reached; and a predetermined number of the identifiers have been associated with the customer-identification information.

18. The system as claimed in claim 13, wherein said server device is further configured to receive identifier-select information from said at least one customer, and said server device is configured to associate said at least one of the identifiers with the customer-identification information according to the identifier-select information.

19. The system as claimed in claim 18, wherein said server device is further configured to provide a graphical user interface to said at least one customer to enable said at least one customer to input the identifier-select information, said graphical user interface being one of a matrix containing the identifiers, and a numerical input interface for inputting numerical values associated with the identifiers.

20. The system as claimed in claim 13, wherein said server device is configured to associate a randomly selected one of the identifiers with the customer-identification information.

21. The system as claimed in claim 13, wherein the benefit is a reduced price for purchase of the product.

22. The system as claimed in claim 21, wherein the benefit is provided to said at least one customer associated with said at least one of the identifiers selected by said server device.

23. The system as claimed in claim 13, wherein said server device includes a storage medium for storing a look-up table of the identifiers and the customer-identification information associated therewith.

24. A non-transitory machine-readable storage medium comprising program instructions which, when executed by a processor of a server device, configure the server device to perform consecutive steps of a method of selling a product online over the Internet according to claim 1.
